(19) United States
(12) Patent Application Publication
(10) Pub. No.: US 2009/0079170 A1
(43) Pub. Date: Mar. 26, 2009

(54) Airbag apparatus for protecting knee

(75) Inventors: Kazuaki Bito, Aichi-ken (JP); Yasuhiro Sakakibara, Aichi-ken (JP); Chiharu Totani, Aichi-ken (JP); Takahiko Sato, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD, Aichi-ken (JP)

(21) Appl. No.: 12/232,759

(22) Filed: Sep. 23, 2008

(30) Foreign Application Priority Data
Sep. 25, 2007 (JP) 2007-247675

(51) Int. Cl. B60R 21/16

(52) U.S. Cl. 280/730.1

(57) ABSTRACT

An airbag apparatus for protecting knees is provided. A breakable portion is provided in a wall of a glove compartment door for opening and closing an opening of a glove compartment. The wall faces a vehicle passenger compartment. An airbag case for housing an airbag, which is inflated by inflation fluid, is installed inside the wall. A front part of the airbag case is caused to function as a pressure receiving portion for receiving a pressure of the inflation fluid through the inflating airbag, thereby generating a reaction force advancing toward the rear side of the vehicle, so that the breakable portion is broken by the airbag inflating toward the rear side of the vehicle. The airbag is caused to protrude from the glove compartment door to the rear side of the vehicle through the breakable portion. A reinforcement member for reinforcing the glove compartment door is provided inside the wall and is fixed to a part other than the breakable portion of the glove compartment door, and the airbag case is attached to the reinforcement member.

### BACKGROUND OF THE INVENTION

The present invention relates to an airbag apparatus for protecting knees that can protect passenger's knees by an airbag installed in a glove compartment door for opening and closing an opening of a glove compartment.

In vehicles, when an impact is applied from the front side to the vehicle by a front collision, etc., there is a problem that knees of a passenger seated on a seat such as a front passenger seat collides with an interior component, for example, the door of a glove compartment positioned at the front side of the seat. Accordingly, an airbag apparatus for protecting knees in which an airbag is installed in the glove compartment door is proposed (for example, see Patent Document 1). According to the airbag apparatus, the airbag is inflated by an inflation fluid such as an inflation gas in response to an impact applied to the vehicle. The airbag shoots out to the rear side of the vehicle from the glove compartment door through a breakable portion by breaking a wall facing the passenger compartment of the glove compartment door at the breakable portion. The airbag restrains the passenger's knees by interposing between the passenger's knees and the glove compartment door and reduces an impact applied to the knees.

In the airbag apparatus for protecting knees, it is necessary to reliably break the breakable portion by inflating the airbag to only the rear side of the vehicle. For this reason, it is important that a part other than the breakable portion in the glove compartment door has rigidity higher than the breakable portion, to thereby generate a reaction force advancing toward the rear side of the vehicle by receiving a pressure of an inflation gas advancing toward the front side of the vehicle.

Therefore, in the airbag apparatus for protecting knees disclosed in the Patent Document 1, a configuration of supporting the glove compartment door through a support member by a vehicle body strengthening member having a high rigidity is adapted. Specifically, in the glove compartment door, at a location rotatably supported by a hinge shaft under the glove compartment door, a lower support member is interposed between a dash panel as a vehicle body strengthening member and the hinge shaft. Further, an upper support member is interposed between an upper part of the glove compartment door and a reinforcement as a vehicle body strengthening member. As the upper support member, for example, a component including a plurality of members and extended/contracted or bent in conjunction with opening and closing of the glove compartment door may be employed, in addition to a component including a single member formed in a bar shape.

According to the airbag apparatus for protecting knees, the rigidity of a part other than the breakable portion of the glove compartment door is enhanced by the upper support member, the lower support member, the dash panel, and the reinforcement. Since the pressure of an inflation gas advancing toward the front side of the vehicle within the airbag is received by the glove compartment door (a part other than the breakable portion) of a high rigidity as described above, a reaction force advancing toward the rear side of the vehicle is generated. Since the reaction force is added to the pressure of the inflation gas advancing toward the rear side of the vehicle, the glove compartment door is easily broken at the breakable portion.

Patent Document 1: Japanese Laid-Open Patent Publication No. 2002-347565

However, in the airbag apparatus for protecting knees described in the Patent Document 1, a scheme for enhancing the rigidity of the part other than the breakable portion of the glove compartment door is performed only outside the glove compartment door, and is not performed to the glove compartment door itself. Accordingly, in the glove compartment door, the rigidity of the part other than the breakable portion is not sufficiently enhanced, the pressure of an inflation gas advancing toward the front side of the vehicle cannot be received, and thus the part, for example, a front side part may be deformed toward the front side of the vehicle. In this case, it is difficult to sufficiently generate a reaction force advancing toward the rear side of the vehicle, and breakage of the breakable portion by the airbag, and furthermore, the inflation of the airbag toward the rear side of the vehicle may not be performed as intended.

### SUMMARY OF THE INVENTION

The present invention has been made in the light of the circumstances described above, and an objective of the invention is to provide an airbag apparatus for protecting knees that sufficiently generates a reaction force advancing toward the rear side of the vehicle by reliably receiving at the glove compartment door the pressure of an inflation fluid such as an inflation gas for inflating an airbag.

To achieve the foregoing objective and in accordance with a first aspect of the present invention, an airbag apparatus for protecting knees is provided. A breakable portion is provided in a wall of a glove compartment door for opening and closing an opening of a glove compartment. The wall faces a vehicle passenger compartment. An airbag case for housing an airbag, which is inflated by inflation fluid, is installed inside the wall. A front part of the airbag case is caused to function as a pressure receiving portion for receiving a pressure of the inflation fluid through the inflating airbag, thereby generating a reaction force advancing toward the rear side of the vehicle, so that the breakable portion is broken by the airbag inflating toward the rear side of the vehicle. The airbag is caused to protrude from the glove compartment door to the rear side of the vehicle through the breakable portion. A reinforcement member for reinforcing the glove compartment door is provided inside the wall and is fixed to a part other than the breakable portion of the glove compartment door, and the airbag case is attached to the reinforcement member.

According to the configuration, the airbag apparatus for protecting knees basically operates as follows. If an inflation fluid is supplied to the airbag, the airbag starts to inflate. At this time, as a front part of the airbag case functions as a pressure receiving portion, a pressure of an inflation fluid advancing toward the front side of the vehicle is received by the front part through the airbag. According to the reception, a reaction force advancing toward the rear side of the vehicle generates. In the airbag, in addition to the pressure of the inflation fluid advancing toward the rear side of the vehicle, the reaction force operates. The airbag inflates to the rear side of the vehicle, presses a wall facing a passenger compartment of the glove compartment door, and breaks the wall at the breakable portion. The airbag shoots out from the glove compartment door to the rear side of the vehicle through the broken breakable portion. The airbag is interposed between passenger's knees seated on a seat and the glove compartment door, restrains the knees, and reduces the impact applied to the knees.

If the rigidity of the airbag case is not sufficiently high, the airbag case is deformed by a pressure of an inflation fluid advancing toward the front side of the vehicle, and thus the airbag case does not sufficiently function as a pressure receiving portion, and a reaction force advancing toward the rear side of the vehicle may not be sufficiently generated.

In this respect, according to the invention, at the front side of the wall of the glove compartment door in the vehicle, the airbag case is attached to the reinforcement member. Further, the reinforcement member is fixed to a part other than the breakable portion of the glove compartment door. With this configuration, the rigidity of the part other than the breakable portion of the glove compartment door is enhanced by the reinforcement member. Further, the rigidity of the airbag case is enhanced by the reinforcement member inherently having a high rigidity and is enhanced by the part having a high rigidity because of the reinforcement member, as described above.

Therefore, even if the airbag case receives a pressure of an inflation fluid, the airbag case having a high rigidity as described above is hardly deformed. Since a pressure of an inflation fluid advancing toward the front side of the vehicle is reliably received by the front part of the airbag case, a reaction force advancing toward the rear side of the vehicle is sufficiently generated. As a result, by causing the airbag to perform the above-described basic operation, i.e. by inflating the airbag toward the rear side of the vehicle and causing the airbag to protrude from the glove compartment door to the rear side of the vehicle through the breakable portion, passenger's knees is protected.

A first latch member is preferably fixed to the outside of the airbag case, and the airbag case is preferably attached to the reinforcement member through the first latch member. In this case, the latch member extends over the airbag case and the reinforcement member, so that the airbag case is coupled to the reinforcing member by means of the latch member.

In this way, with the configuration using the latch member separately from the airbag case and the reinforcement member, even when the airbag case and the reinforcement member are close to each other, or even when the airbag case and the reinforcement member are disposed at a great distance, a latch member having a length according to such a distance is used and thus the airbag case is reliably attached to the reinforcement member.

A lock device is preferably provided in the glove compartment. A part of the constituent members of the lock device is disposed at the glove compartment door in order to hold the glove compartment door at a closed position. The constituent member disposed at the glove compartment door among the constituent members of the lock device functions as the reinforcement member.

According to the configuration, in the lock device, a constituent member having a high rigidity is generally used in order to exhibit a function of holding the glove compartment door at a closed position. In the lock device, a constituent member disposed at the wall of the glove compartment door is used as a reinforcement member, and the airbag case is attached to the constituent member. With the configuration, the rigidity of the airbag case is enhanced by the constituent member of the lock device.

A lock device is preferably provided in the glove compartment. A part of the constituent members of the lock device is disposed at the glove compartment door in order to hold the glove compartment door at a closed position. The airbag case is attached to the constituent member disposed at the glove compartment door among the constituent members of the lock devices, as well as to the reinforcement member.

According to the configuration, in the lock device, a constituent member having a high rigidity is generally used in order to exhibit a function of holding the glove compartment door at a closed position. The airbag case is attached to a constituent member close to the glove compartment door among the constituent members, in addition to the reinforcement member. With this configuration, the rigidity of the airbag case is enhanced by the constituent member of the lock device.

A second latch member is preferably fixed to the outside of the airbag case. In the second latch member, the airbag case is attached to the constituent member disposed at the glove compartment door among the constituent members of the lock device.

In this case, since the second latch member extends over the airbag case and the constituent member of the lock device, the airbag case is connected to the constituent member of the lock device through the second latch member.

In this way, with the configuration using the second latch member separately from the airbag case and the lock device, even when the airbag case and the lock device are close to each other, or even when the airbag case and the lock device are disposed at a great distance, the second latch member having a length according to such a distance is used and thus the airbag case can be reliably attached to a constituent member of the lock device that is close to the glove compartment door.

The lock device preferably includes, as the constituent members, an engaging hole that is installed in a wall of the opening of the glove compartment, and a lock member that is provided in the glove compartment door. The lock member is displaced between an engaging position, where the lock member engages with the engaging hole to hold the glove compartment door at a closed position, and a disengaging position, where the lock member is removed from the engaging hole to cancel the engagement. The second latch member is movably latched to the lock member.

In such a type lock device, if the lock member engages with an engaging hole by being displaced from the glove compartment door up to an engaging position, the glove compartment door is held at a closed position. In contrast, if the lock member escapes from the engaging hole by being displaced up to a disengaging position, the engagement of the lock member is canceled, and the glove compartment door can be opened.

The second latch member is preferably latched to the lock member so to be movable relative to the lock member.

According to the configuration, since the second latch member extends over the airbag case and the lock member, the airbag case is connected to a constituent member of the lock device through the second latch member.

In addition, the second latch member is latched to the lock member so as to be movable relative to the lock member instead of being tightly coupled to the lock member. Therefore, even if the second latch member is immovably installed in the glove compartment door, the lock member can move relative to the second latch member. As a result, the second latch member hardly disturbs the displacement of the lock member.

The lock device includes, as the constituent member, a striker installed at one of the opening of the glove compartment door and of the glove compartment door, a manipulation member that is provided in the other one of the opening and the door and is rotatably supported by a shaft, and a hook that can be displaced, according to a rotation of the manipulation member, between an engaging position holding the glove compartment door at a closed position by engaging with the striker and a disengaging position canceling the engagement.

In the lock device, if the manipulation member rotates using the shaft as a fulcrum, the hook is displaced between an engaging position and a disengaging position according to a rotation of the manipulation member. If the hook engages with the striker by being displaced up to an engaging position, the glove compartment door is held at a closed position. In contrast, if the hook is displaced up to a disengaging position, the engagement of the hook to the striker is canceled, and the glove compartment door can be opened.

Further, the airbag case is preferably attached to a constituent member among the striker and the shaft that is provided at the glove compartment door.

According to the configuration, since the second latch member extends over the airbag case and the constituent member (striker or shaft) of the lock device, the airbag case is connected to the constituent member (striker or shaft) of the lock device through the second latch member.

Further, when an attaching object of the second latch member is a shaft and the shaft rotates together with the manipulation member relative to the glove compartment door, it is preferable that the second latch member is relative-rotatably latched to the shaft instead of being tightly coupled to the shaft. By adapting such a latch structure, the shaft can rotate relative to the second latch member even if the second latch member is immovably installed in the glove compartment door. Accordingly, the second latch member hardly disturbs a rotation of the shaft.

An end portion of the reinforcement member is preferably positioned at a peripheral edge of the opening. A support member for connecting the end portion of the reinforcement member to a vehicle body strengthening member is provided.

According to the configuration, the pressure of an inflation fluid advancing toward the front side of the vehicle is received by a vehicle body strengthening member through the reinforcement member and the support member. Thereby, the rigidity of the reinforcement member is further enhanced and thus the rigidity of the airbag case is enhanced.

### BRIEF DESCRIPTION OF THE DRAWINGS

FIG. 1 is a partial perspective view illustrating a glove compartment to which an airbag apparatus for protecting knees is applied and a surrounding part thereof according to one embodiment of the present invention;

FIG. 2 is a cross-sectional view of the airbag apparatus for protecting knees according to the embodiment;

FIG. 3 is a cross-sectional view taken along line 3-3 of FIG. 2, illustrating a sectional structure of the airbag apparatus for protecting knees;

FIG. 4 is a cross-sectional view taken along line 4-4 of FIG. 2, illustrating a sectional structure of the airbag apparatus for protecting knees;

FIG. 5 is a cross-sectional view taken along line 5-5 of FIG. 2, illustrating a sectional structure of the airbag apparatus for protecting knees;

FIG. 6 is a cross-sectional view illustrating an operation protecting passenger's knees by the airbag apparatus for protecting knees according to the embodiment of the present invention; and

FIG. 7 is a cross-sectional view corresponding to FIG. 2, illustrating an airbag apparatus for protecting knees according to another embodiment of the present invention.

### DETAILED DESCRIPTION OF THE PREFERRED EMBODIMENTS

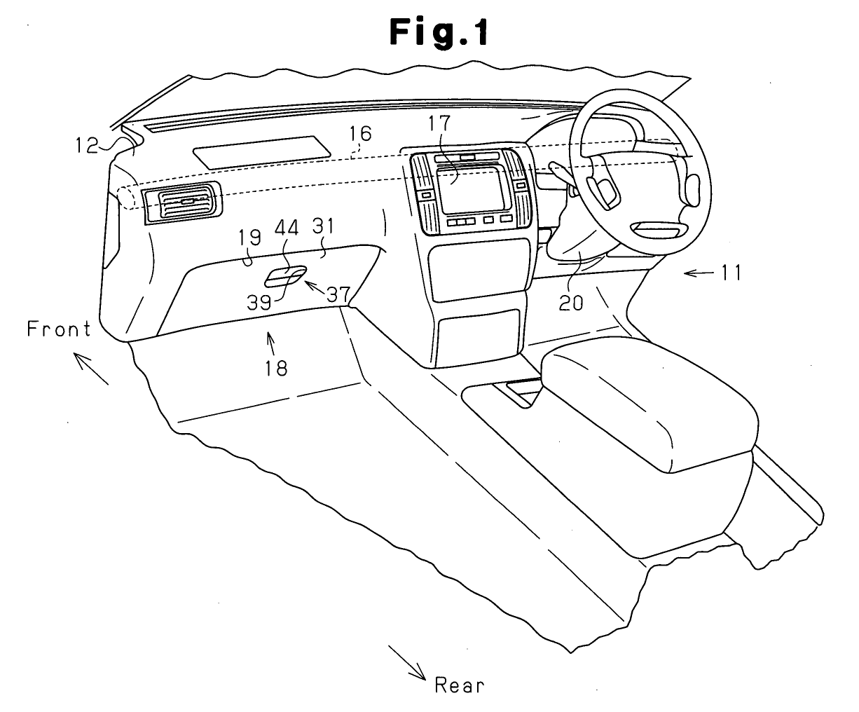

Hereinafter, an embodiment according to the present invention is described with reference to FIGS. 1 to 6. In the following description, the front side designates an advancing direction of a vehicle, and the rear side, the upper part, the lower part, the left side, and the right side are defined in relation to the front side. Further, in the drawings, “the front side” indicates the front side in the vehicle, and “the rear side” indicates the rear side in the vehicle.

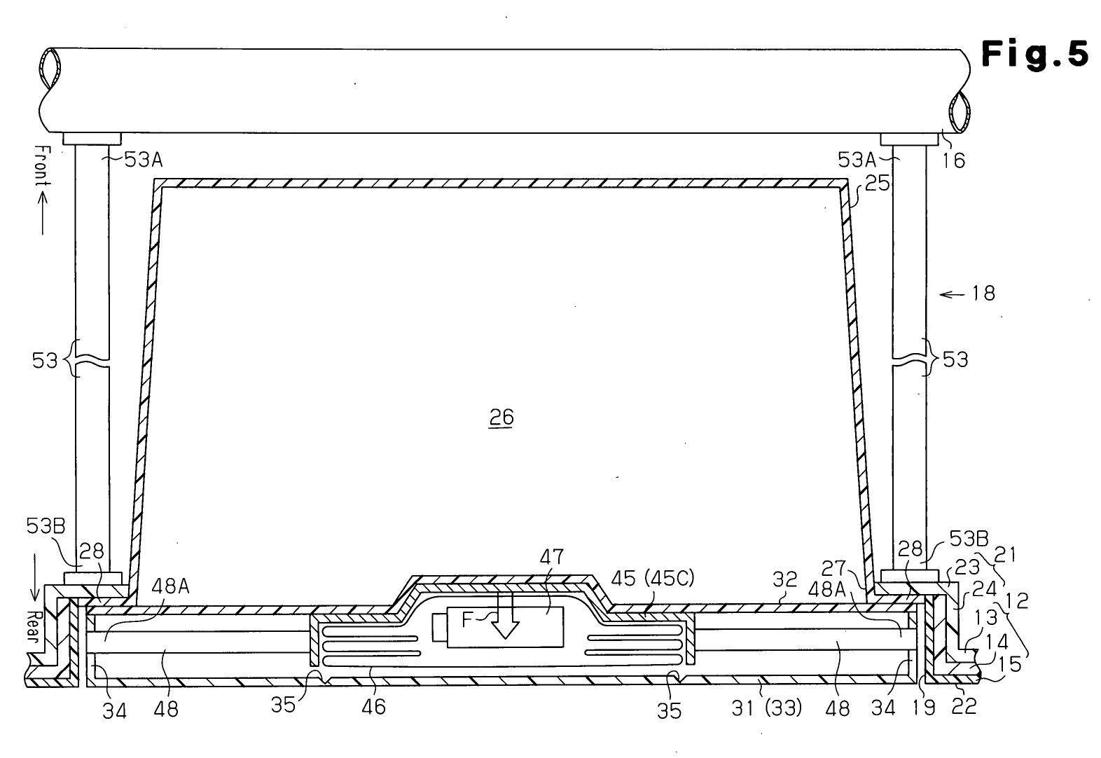

As shown in at least one of FIGS. 1 and 5, in a front part within a passenger compartment of a vehicle 11, an instrument panel 12 is installed over substantially the entirety a vehicle-width direction (a lateral direction of FIG. 1). The instrument panel 12 is formed in a three-layered structure including, for example, a base 13 that is made of a hard resin, etc., a foam layer 14 that is stacked on the base 13, and an outer cover layer 15 that is stacked on the foam layer 14.

An instrument panel reinforcement 16 having a slim pipe shape in a vehicle-width direction is disposed in an upper part within the instrument panel 12. The instrument panel reinforcement 16 is fixed to a front fender (not shown) of the vehicle at both end portions thereof. The instrument panel reinforcement 16 is an existing vehicle body strengthening member for installing various parts such as the instrument panel 12, a steering column 20, and a front passenger seat airbag apparatus. Further, a strengthening member called a brace (not shown) extending downward is attached to the instrument panel reinforcement 16. For example, a display unit 17 of a navigation system is attached to the brace.

A glove compartment 18 is provided in the instrument panel 12 at a location in front of the front passenger seat (not shown). Specifically, at the location of the instrument panel 12, a mounting hole 19 having substantially a rectangular shape is formed. A step part 21 is formed in a peripheral edge of the mounting hole 19 in the instrument panel 12. The step part 21 includes a front wall 23 positioned slightly forward of a general portion 22 of the instrument panel 12 and a side wall 24 for connecting the general portion 22 and the front wall 23.

Most part of the glove compartment 18 is formed by a compartment body 25 having substantially a rectangular parallelepiped shape. The inside of the compartment body 25 is a housing space 26 for housing small items, a document, etc. An opening 27 for opening the housing space 26 toward the rear side and putting in or taking out small items is formed at the rear end of the compartment body 25. In a periphery of the opening 27 of the compartment body 25, a flange 28 is integrally formed. The compartment body 25 is inserted into the mounting hole 19 from the rear side of the instrument panel 12, and the flange 28 is bonded to the front wall 23 of the step part 21.

The glove compartment 18 has a glove compartment door 31 for opening and closing the opening 27, in addition to the compartment body 25. The glove compartment door 31 includes a front wall 32 and a rear wall 33 that are disposed apart from each other, and a peripheral wall 34 that is positioned between a surrounding part of the front wall 32 and a surrounding part of the rear wall 33. The peripheral wall 34 is formed integrally with the rear wall 33. The rear wall 33 corresponds to a wall facing the passenger compartment and a rear surface thereof forms an ornamental surface of the glove compartment 18. In the rear wall 33, a breakable portion 35 to be broken by an airbag 46 to be described later is formed. The breakable portion 35 is formed so that a part of a central part of the rear wall 33 has a thickness smaller than other part of the rear wall 33. The breakable portion 35 is obtained by forming, for example, a tear line groove of an H shape when viewed from the front passenger seat.

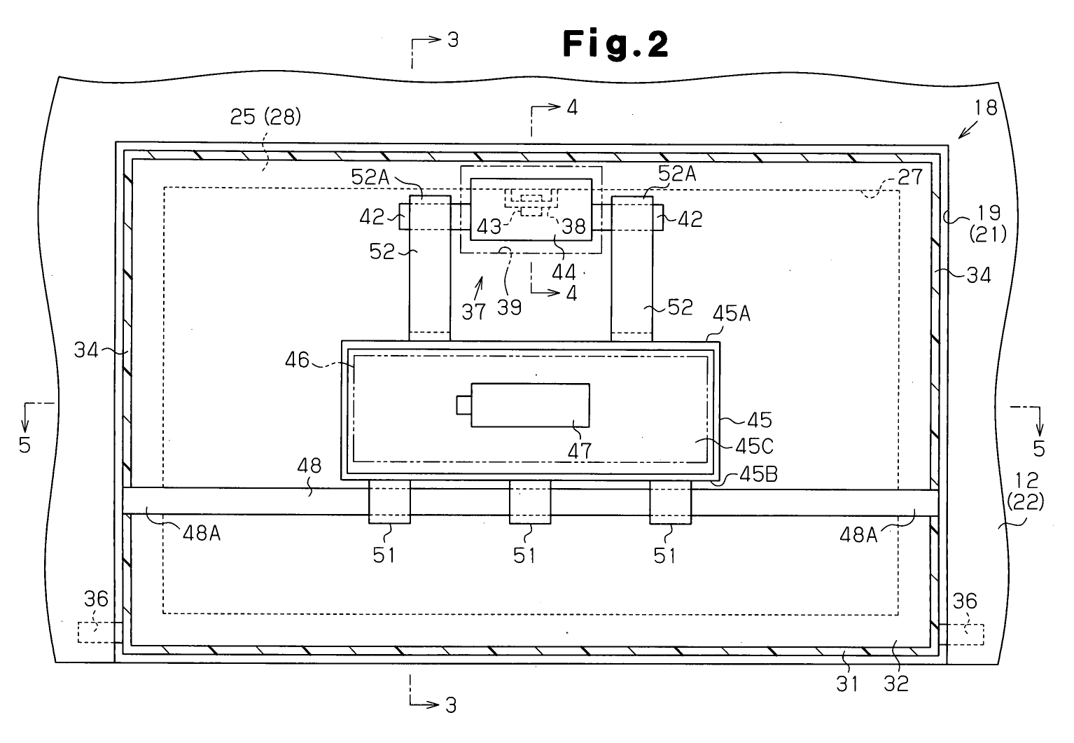

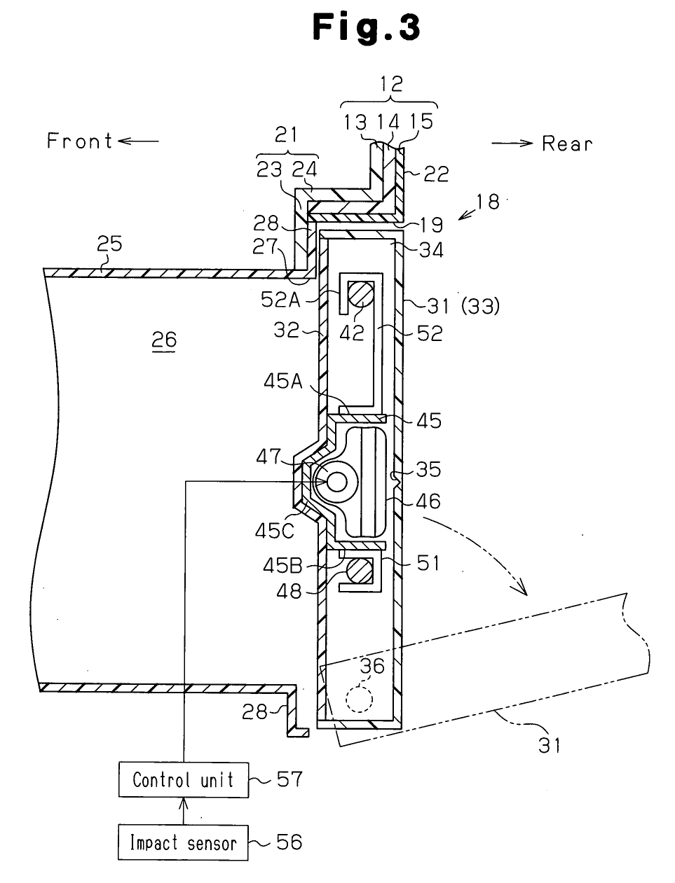

As shown in at least one of FIGS. 2 and 3, in a lower end portion of the peripheral wall 34, the glove compartment door 31 is supported by the side wall 24 of the step part 21 by the shaft 36. The glove compartment door 31 can rotate using the shaft 36 as a fulcrum between a position closing the opening 27 in substantially a upright state, as indicated by solid lines in FIG. 3 and a position widely opening the opening 27 substantially in a horizontal state, as indicated by two-dot chain lines in FIG. 3.

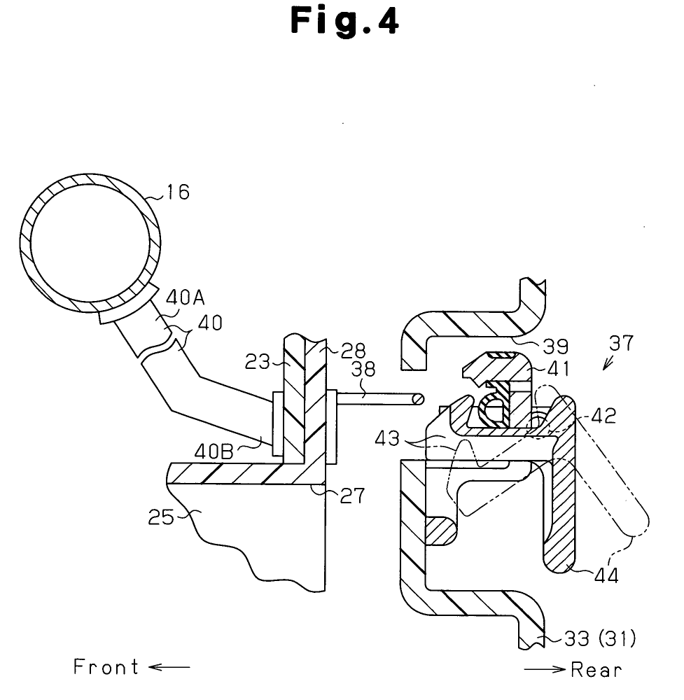

As shown in at least one of FIGS. 2 and 4, between the compartment body 25 and the glove compartment door 31, a lock device 37 is provided between the compartment body 25 and the glove compartment door 31. The lock device 37 holds (locks) the glove compartment door 31 at a closed position and cancels the locking by manipulating the manipulation member. In the configuration of the lock device 37, a striker 38 is attached to the flange 28 of the compartment body 25. The striker 38 is formed by bending a metal rod in a U shape, and both end portions thereof are fixed to the flange 28.

At the center of an upper part of the rear wall 33 of the glove compartment door 31, an opened recess 39 is formed in the rear surface of the rear wall 33. A lever holder 41 is fixed to the recess 39, and a shaft 42 protrudes from the lever holder 41 toward both sides of a vehicle-width direction. The shaft 42 is unrotatably attached to the lever holder 41. A manipulation lever 44 having a hook 43 is installed as a manipulation member within the recess 39 at the rear side of the lever holder 41. The manipulation lever 44 is rotatably attached to the shaft 42. In this way, the manipulation lever 44 is rotatably supported by the lever holder 41 (the glove compartment door 31) by the shaft 42. The hook 43 engages with the striker 38 according to a rotation of the manipulation lever 44 and can displace between an engaging position holding the glove compartment door 31 at a closed position and a disengaging position canceling the engagement. Further, a spring (not shown) for constantly biasing the hook 43 toward an engaging position side is interposed between the hook 43 and the lever holder 41.

As described above, the striker 38 is positioned at the front wall 23 of the step part 21 and at the rear side of the flange 28 in the upper portion of the compartment body 25. In the front wall 23 and at the front side of the flange 28, a support member 40 for supporting the striker 38 to the instrument panel reinforcement 16 is provided. The support member 40 is fixed to the instrument panel reinforcement 16 in a front end portion 40A thereof and is fixed to the front wall 23 in the rear end portion 40B thereof. The rigidity of the striker 38 is enhanced by the instrument panel reinforcement 16 and the support member 40.

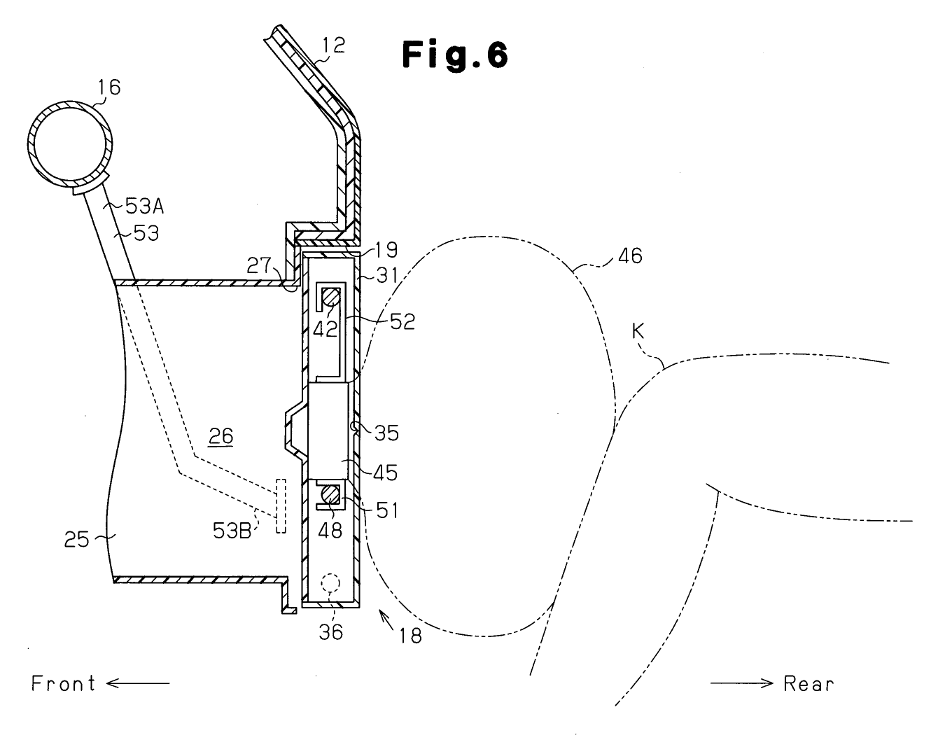

An airbag apparatus for protecting knees is provided in the vehicle 11. When an impact from the front side is applied to the vehicle 11 due to a front collision, the airbag apparatus protects knees K (see FIG. 6) of a passenger seated on a seat such as a front passenger seat from contacting the glove compartment door 31, etc. of the glove compartment 18. Specifically, as shown in at least one of FIGS. 2 and 5, the airbag case 45 is installed in a part that is relative to the inside of the glove compartment door 31 and that is separated downward from the lock device 37, for example, in a central part within the glove compartment door 31. The airbag case 45 is installed at the front side of the rear wall 33 of the glove compartment door 31 in the vehicle. The airbag case 45 is formed with a plate such as a metal plate and is formed in a box shape with a rear surface opened and a shallow depth.

Within the airbag case 45, an airbag 46 is housed in a folded state folded. The airbag 46 is formed of fabric cloth made of polyester yarn, polyamide yarn, etc. The airbag 46 has a size occupying space between the glove compartment door 31 and the passenger's knees K when inflated (see FIG. 6).

At the inside of the airbag 46, an inflator 47 is installed as a source of an inflation fluid. A gas generating agent (not shown) for generating an inflation gas as the inflation fluid is housed at the inside of the inflator 47. In such a type (pyro type) of inflator 47, the inflation gas generates by a combustion reaction of a gas generating agent. Further, as the inflator 47, a hybrid type inflator may be used instead of the pyro type inflator using the gas generating agent. The hybrid type inflator ejects an inflation gas by breaking using gunpowder a partition wall of a high pressure gas cartridge in which a high pressure gas is charged.

The airbag 46 and the inflator 47 are fastened to the airbag case 45 by a fastening member (not shown) such as a bolt and a nut.

A reinforcement member 48 for reinforcing the glove compartment door 31 is disposed in the glove compartment door 31 directly under the airbag case 45. The reinforcement member 48 is disposed at the front side of the rear wall 33 of the glove compartment door 31. The reinforcement member 48 is formed in a slim bar shape in a vehicle-width direction, and end portions 48A of both sides thereof are positioned at both sides of the glove compartment door 31 in a vehicle-width direction. The reinforcement member 48 is fixed to a location, and in this case, to the peripheral wall 34 other than the breakable portion 35 in the glove compartment door 31.

As shown in at least one of FIGS. 2 and 3, the airbag case 45 is attached to the reinforcement member 48 by latch members 51 each formed with a plate such as a metal plate. That is, the latch members 51 are fixed in a lower surface 45B of the airbag case 45 at each of a plurality of locations (three locations in FIGS. 2) apart from each other in a vehicle-width direction. Since each of the latch members 51 is bent in U shape, the latch members 51 are latched to the reinforcement member 48 from the rear side.

Further, the airbag case 45 is attached to the shaft 42 of the lever holder 41 by second latch members 52 each formed with a plate such as a metal plate. That is, the second latch members 52 are fixed in an upper surface 45A of the airbag case 45 at each of a plurality of locations apart from each other in a vehicle-width direction, more accurately, at two locations corresponding to the shaft 42. A latch 52A having a cross-section of an inverted U shape is formed with bent in an upper part of each of the second latch members 52. In the latch 52A, each of the second latch members 52 is latched to the corresponding shaft 42 from above.

As shown in FIG. 5, as described above, the end portion 48A of the reinforcement member 48 is positioned at both side parts of the glove compartment door 31 in a vehicle-width direction and is positioned at the rear side of a peripheral edge of the opening 27 of the compartment body 25. A support member 53 is provided in the peripheral edge of the opening 27 at the front side of each of the end portions 48A of the reinforcement member 48. The support member 53 supports the end portion 48A to the instrument panel reinforcement 16, which is a vehicle body strengthening member. The support member 53 is elongated, and is fixed to the instrument panel reinforcement 16 in a front end portion 53A thereof and is fixed to the front wall 23 of the step part 21 in a rear end portion 53B thereof.

As shown in FIG. 3, the airbag apparatus for protecting knees includes an impact sensor 56 and a control unit 57. The impact sensor 56 includes an acceleration sensor, etc. and is installed in a front bumper (not shown) of the vehicle 11 so as to detect an impact applied from the front of the vehicle 11. The control unit 57 controls an operation of the inflator 47 based on a detection result of the impact sensor 56.

For example, when no impact applied to the vehicle 11 (front bumper) is detected by the impact sensor 56, such as when a vehicle normally travels, an command signal (ignition signal) for commanding to generate an inflation gas from the control unit 57 to the inflator 47 is not output. As the inflation gas is not ejected from the inflator 47, the airbag 46 does not inflate and remains folded within the airbag case 45. Therefore, it is possible to open and close the glove compartment door 31 without difficulty. For example, when the manipulation lever 44 is not operated in a state where the glove compartment door 31 is positioned at a closed position by making the glove compartment door 31 upright, the hook 43 that is biased to rate by a spring engages with the striker 38 at an engaging position. By the engagement, the glove compartment door 31 is held at a closed position, and the opening 27 of the compartment body 25 is filled with the glove compartment door 31. Thereby, loss of mall items housed within the compartment body 25 is prevented.

If the hook 43 is displaced from the engaging position to a disengaging position by manipulating the manipulation lever 44 against the spring in the above state, the engagement of the hook 43 and the striker 38 is canceled. Thereby, it is possible to rotate the glove compartment door 31 from a closed position to an opening position using the shaft 36 as a fulcrum. In the open position, since the glove compartment door 31 is in substantially a horizontal state, the opening 27 of the compartment body 25 is widely opened and thus small items, etc. can be put in and taken out through the opening 27.

Further, in the above state, when rotating the glove compartment door 31 from an opening position to a closed position using the shaft 36 as a fulcrum and removing a hand from the manipulation lever 44, the hook 43 returns from a disengaging position, while being biased by the spring to an engaging position and engages with the striker 38, and thus the glove compartment door 31 is held at the closed position.

Further, as described above, when the glove compartment door 31 rotates, the airbag case 45, the airbag 46, the inflator 47, the reinforcement member 48, the latch members 51, and the second latch members 52 are formed integrally with the glove compartment door 31 and displaced about the shaft 36. The airbag case 45, etc. do not disturb a rotation of the glove compartment door 31.

When an impact applied to the vehicle 11 (front bumper) due to a front collision of the vehicle 11 is detected by an impact sensor 56, a command signal (ignition signal) for commanding to generate an inflation gas from the control unit 57 to the inflator 47 is output. The inflator 47 ignites in response to the command signal, and the inflation gas is ejected and supplied to the airbag 46. A pressure of the inflation gas is applied to each part of the airbag 46, and the airbag 46 starts to inflate. At this time, the airbag case 45, particularly, a front part (inside bottom 45C) functions as a pressure receiving portion, and the pressure of an inflation gas advancing toward the front side of the vehicle is received by the inside bottom 45C through the airbag 46. Thereby, a reaction force F advancing toward the rear side of the vehicle generates (see FIG. 5). In addition to the pressure advancing toward the rear side of the vehicle, the reaction force F acts on the airbag 46. The airbag 46 inflates to the rear side of the vehicle, presses the rear wall 33 of the glove compartment door 31, and breaks the breakable portion 35 of the rear wall 33. As indicated by two-dot chain lines of FIGS. 6, the airbag 46 shoots out from the glove compartment door 31 to the rear side of the vehicle through the broken breakable portion 35. The airbag 46 is interposed between passenger's knees K seated on a front passenger seat and the glove compartment door 31, restrains the knees K, and reduces the impact applied to the knees K.

If the rigidity of the airbag case 45 is not sufficiently high, the airbag case 45 is deformed by the pressure of the inflation gas advancing toward the front side of the vehicle and does not sufficiently function as a pressure receiving portion, and the reaction force F advancing toward the rear side of the vehicle may not be sufficiently generated.

In the present embodiment, as shown in at least one of FIGS. 2 and 3, the latch members 51 are fixed to a plurality of locations of the lower surface 45B of the airbag case 45. The airbag case 45 is attached to the reinforcement member 48 at the latch members 51. The latch members 51 extend over the airbag case 45 and the reinforcement member 48, and the airbag case 45 is connected to the reinforcement member 48 through the latch members 51. Each latch member 51 is formed through a bending processing of a metal plate and inherently has a high rigidity. Further, the reinforcement member 48 is fixed to a part (the peripheral wall 34) other than the breakable portion 35 of the glove compartment door 31.

With the configuration, the rigidity of a part other than the breakable portion 35 of the glove compartment door 31 is enhanced by the reinforcement member 48. Further, the rigidity of the airbag case 45 is enhanced by the reinforcement member 48 inherently having a high rigidity and by the part having a high rigidity because of the reinforcement member 48, as described above.

Further, in the lock device 37, a constituent member having a high rigidity including the shaft 42 is generally used in order to exhibit a function of holding the glove compartment door 31 at a closed position. The second latch members 52 are fixed to the upper surface 45A of the airbag case 45, in addition to the reinforcement member 48. The airbag case 45 is installed by means of the second latch members 52 and a constituent member (the shaft 42) disposed within the glove compartment door 31 among the constituent members of the lock device 37. The second latch members 52 extend over the airbag case 45 and the shaft 42, and the airbag case 45 is connected to the shaft 42 of the lock device 37 through the second latch members 52. As described above, the shaft 42 inherently has a high rigidity. Therefore, the rigidity of the airbag case 45 is enhanced by a constituent member (the shaft 42) of the lock device 37.

Further, the pressure of inflation gas advancing toward the front side of the vehicle is received by the instrument panel reinforcement 16 through the reinforcement member 48 and the support member 53. Thereby, the rigidity of the reinforcement member 48 is further enhanced, and thus the rigidity of the airbag case 45 is enhanced. A phenomenon that the reinforcement member 48 further moves to the front side of the vehicle is suppressed.

In addition, a pressure of an inflation gas advancing toward the front side of the vehicle is applied to the compartment body 25 through the lock device 37. However, the pressure is received by the instrument panel reinforcement 16 through the front wall 23 of the step part 21 and the support member 40. Thereby, the rigidity of the airbag case 45 is enhanced.

Accordingly, even if the airbag case 45 receives a pressure of an inflation gas advancing toward the front side of the vehicle, the airbag case 45 having a high rigidity as described above is hardly deformed. Since the pressure of the inflation gas advancing toward the front side of the vehicle is reliably received by the inside bottom 45C of the airbag case 45, a reaction force F advancing toward the rear side of the vehicle is sufficiently generated.

According to the above-described embodiment, the following advantage are obtained.

(1) The reinforcement member 48 is installed at the front side of the rear wall 33 of the glove compartment door 31 and is fixed to a part other than the breakable portion 35 of the glove compartment door 31, and the airbag case 45 is attached to the reinforcement member 48. By such a configuration, the rigidity of the airbag case 45 is enhanced, and thus the airbag case 45 is hardly deformed when receiving the pressure of an inflation gas. Since a pressure of the inflation gas advancing toward the front of the vehicle is reliably received by the inside bottom 45C, which is the front part of the airbag case 45, a reaction force F advancing toward the rear side of the vehicle is sufficiently generated. As a result, by causing the airbag 46 to perform an intended operation, i.e. an operation of causing the airbag 46 to protrude toward the rear side of the vehicle from the glove compartment door 31 through the breakable portion 35 by inflating the airbag 46 toward the rear side of the vehicle, the passenger's knees K are appropriately protected from an impact due to a contact with the glove compartment 18.

(2) Adapted is a configuration of fixing the latch members 51 to the downside of the airbag case 45 and installing the airbag case 45 in the reinforcement member 48 at the latch members 51. In this way, with the configuration of using the latch members 51 separately from the airbag case 45 and the reinforcement member 48, even when the airbag case 45 and the reinforcement member 48 are close to each other, or even when the airbag case 45 and the reinforcement member 48 are disposed at a great distance, the latch members 51 having a length according to such the distance are used and thus the airbag case 45 can be reliably attached to the reinforcement member 48.

(3) In the glove compartment 18, in order to hold the glove compartment door 31 in a closed state, in an installation location of the lock device 37 that disposes a part of constituent members thereof in the glove compartment door 31, the airbag case 45 is installed in a constituent member disposed (the shaft 42) at a position closer to the glove compartment door 31 among the constituent members of the lock device 37, in addition to the reinforcement member 48. In this way, by installing the glove compartment 18 in the shaft 42 having a high rigidity, the rigidity of the airbag case 45 is enhanced, and thus the advantages of the items (1) and (2) are more reliably obtained.

(4) Adapted is a configuration of fixing the second latch members 52 to the upside of the airbag case 45 and installing the airbag case 45 in the shaft 42 of the lock device 37 at the second latch members 52. In this way, with the configuration of using the second latch members 52 separately from the airbag case 45 and the lock device 37, even when the airbag case 45 and the lock device 37 are close to each other, or even when the airbag case 45 and the lock device 37 are disposed at a great distance, the second latch members 52 having a length according to such a distance is used and thus the airbag case 45 can be reliably attached to the lock device 37.

(5) By forming the elongated reinforcement member 48, the end portions 48A of both sides thereof are positioned at both sides of the left side and the right side of the glove compartment door 31, i.e. at the rear side of the peripheral edge of the opening 27 of the compartment body 25. Further, the support member 53 for supporting the end portion 48A to the instrument panel reinforcement 16, which is a vehicle body strengthening member, is installed in the peripheral edge of the opening 27 at the front side of the end portion 48A of the reinforcement member 48. By receiving the pressure of inflation gas advancing toward the front side of the vehicle by the instrument panel reinforcement 16 through the reinforcement member 48 and the support member 53, the rigidity of the reinforcement member 48 is further enhanced, and thus the rigidity of the airbag case 45 is further enhanced.

(6) The support member 40 for supporting the striker 38 to the instrument panel reinforcement 16 is installed at the front side of the flange 28 at the upside of the compartment body 25 in which the striker 38 is installed. Thereby, the pressure of an inflation gas advancing toward the front side of the vehicle is received by the instrument panel reinforcement 16 through the front wall 23 of the step part 21 and the support member 40, and thus the rigidity of the airbag case 45 is further enhanced.

(7) In relation to the advantages of the items (5) and (6), the pressure of inflation gas is received through the support members 40, 53 using the instrument panel reinforcement 16, which is an existing vehicle body strengthening member. Therefore, in order to achieve the same function, there is an advantage that it is unnecessary to provide a separate strengthening member.

The present invention may be embodied in the following forms.

In the glove compartment 18, to which the present invention is applied, the compartment body 25 may be integrated with the glove compartment door 31, and may be rotatably supported in the mounting hole 19 of the instrument panel 12.

In the lock device 37 of the above-described embodiment, the shaft 42 may be fixed to the manipulation lever 44, and the shaft 42 may be rotatably supported by the lever holder 41. By changing in this way, the shaft 42 responds to a manipulation of the manipulation lever 44, is formed integrally with the manipulation lever 44, and rotates relative to the glove compartment door 31. In this case, it is preferable that the second latch members 52 be rotatably latched to the shaft 42 instead of being tightly coupled to the shaft 42. With the latch structure, even if the second latch members 52 are immovably installed in the glove compartment door 31, the shaft 42 can be rotated relative to the second latch members 52. Accordingly, the second latch members 52 hardly disturb a rotation of the shaft 42.

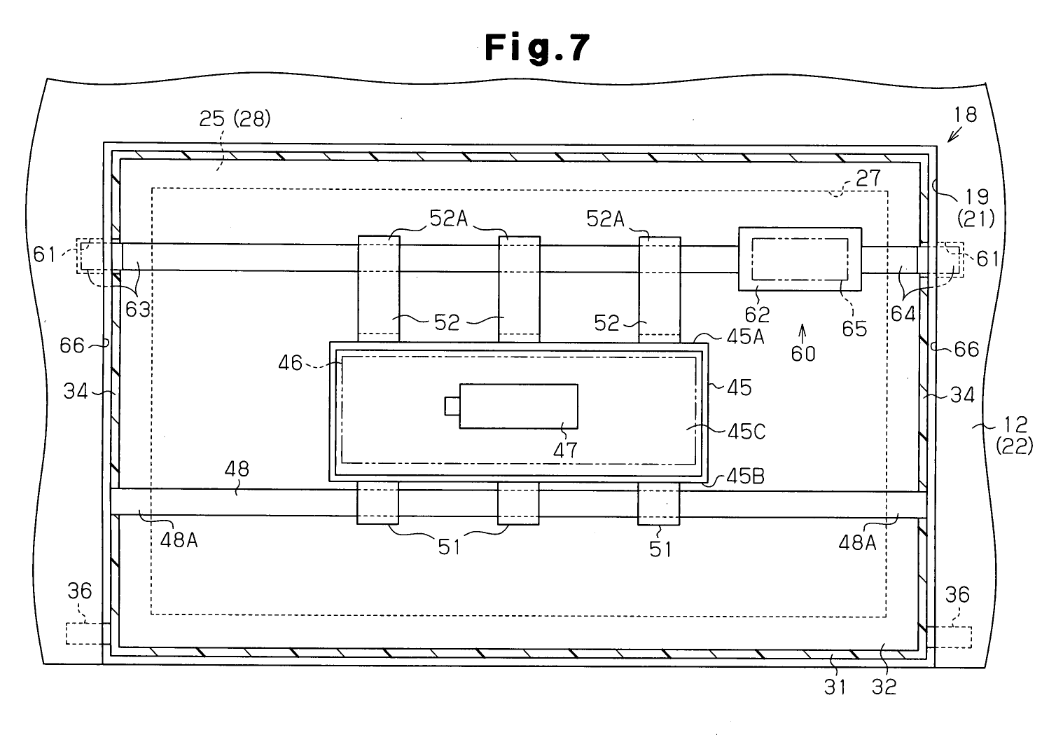

The present invention may be applied to a glove compartment in which a lock device of a type different from that of the above-described embodiment is adapted. FIG. 7 illustrates one example of such a case. Such a type lock device 60 includes a pair of engaging holes 61, 61, a manipulation lever 62, a pair of lock members 63, 64, and a movement direction conversion device 65. In the mounting hole 19 of the instrument panel 12, the pair of engaging holes 61 is formed in each of the opposite walls 66 in a vehicle-width direction. The manipulation lever 62 is rotatably supported by the glove compartment door 31. Since each of the lock members 63, 64 has a cross-section of a rectangular shape and has a slim bar shape in a vehicle-width direction, the lock members 63, 64 are disposed to reciprocate within the glove compartment door 31 in a vehicle-width direction. The movement direction conversion device 65 is installed between the manipulation lever 62 and the lock members 63, 64. The movement direction conversion device 65 converts a rotation of the manipulation lever 62 to a linear motion in the vehicle-width direction, transmits the linear motion to the lock members 63, 64, and allows the lock members (63, 64) to displace between an engaging position (see a two-dot chain line of FIG. 7) holding the glove compartment door 31 at a closed position by engaging with the engaging hole 61 and a disengaging position (see a solid line of FIG. 7) canceling the engagement by escaping from the engaging hole 61. The positions of the lock members 63, 64 are changed simultaneously.

In such a type lock device 60, if the lock members 63, 64 each engage with the corresponding engaging hole 61 by being displaced from the glove compartment door 31 up to the engaging position, the glove compartment door 31 is held at the closed position. In contrast, if the lock members 63, 64 each escape from the corresponding engaging hole 61 by being displaced up to a disengaging position, the engagement of the lock members 63, 64 is canceled, and the glove compartment door 31 can be opened.

In the glove compartment 18 adapting the above type lock device 60, the second latch members 52 fixed to a plurality of locations of the upper surface 45A of the airbag case 45 are movably (slidably) latched to the lock member 63, respectively. Thereby, the second latch members 52 extend over the airbag case 45 and the lock member 63, and thus the airbag case 45 is connected to a constituent member (the lock member 63) within the glove compartment door 31 of the lock device 60 through the second latch members 52.

Each of the second latch members 52 is latched to the lock member 63 so as to be movable relative to the lock member 63 instead of being tightly coupled to the lock member 63. Thus, even if the second latch members 52 are immovably provided within the glove compartment door 31, the lock member 63 can move relative to the second latch members 52. Accordingly, each of the second latch members 52 hardly disturbs displacement of the lock member 63.

In the lock device, as described above, a constituent member having a high rigidity is generally used in order to exhibit a function of holding the glove compartment door 31 at a closed position. A constituent member disposed at a position close to the rear wall 33 of the glove compartment door 31 among the constituent members of the lock device, for example, the shaft 42 in the lock device 37 and the lock members 63, 64 in the lock device 60 may be used as a reinforcement member, and the airbag case 45 may be attached to the constituent member. In this case, similarly to the above-described embodiment, the latch member (the second latch member) may extend over the reinforcement member and the airbag case 45. Thereby, since the rigidity of the airbag case 45 is enhanced by the constituent member of the lock device, the reinforcement member 48 may be omitted in the above-described embodiment.

The present invention may be applied to an airbag apparatus for protecting knees that has no space or less space for disposing the airbag case within the glove compartment door and in which the airbag case is installed at the front side of the glove compartment door. In this case, the airbag case is installed at the front side of a wall facing a passenger compartment of the glove compartment door.

As described above, at a location in which the brace is drooped from the instrument panel reinforcement 16, the support member 40 or the support member 53 may be fixed to the brace instead of the instrument panel reinforcement 16.

In the above-described embodiment, the rear end portion 53B of the support member 53 is fixed to a location of the front side of the end portion 48A of the reinforcement member 48 in the front wall 23 of the step part 21. However in addition to, or instead of this, the rear end portion 53B may be fixed to other parts of the front wall 23, for example, to a part of the upside of the opening 27.

As the reinforcement member 48, a reinforcement member having a shape or a size (length) different from those of the above-described embodiment may be used. It is not always necessary to form the reinforcement member 48 a bar shape.

The airbag case 45 may be directly attached to the reinforcement member 48 without using the latch members 51. Alternatively, the airbag case 45 may be directly attached to constituent members (the shaft 42 and the lock members 63, 64) in the lock devices (37, 60), which members are at positions close to the glove compartment door 31, without using the second latch members 52.

The airbag case 45 may be attached to a part other than the constituent members (the shaft 42, and the lock members 63, 64) in the lock devices (37, 60), which members are at positions close to the glove compartment door 31.

1. An airbag apparatus for protecting knees, comprising
a glove compartment door for opening and closing an opening of a glove compartment provided in a vehicle passenger compartment, the glove compartment door having a breakable portion in a wall facing the passenger compartment; and
an airbag case installed inside the wall, wherein the airbag case has a front part and houses an airbag, which is inflated by inflation fluid,
wherein the front part of the airbag case is caused to function as a pressure receiving portion for receiving the pressure of the inflation fluid through the inflating airbag, thereby generating a reaction force advancing toward the rear side of the vehicle, so that the breakable portion is broken by the airbag inflating toward the rear side of the vehicle, and the airbag is caused to protrude from the glove compartment door to the rear side of the vehicle through the breakable portion, and
wherein a reinforcement member for reinforcing the glove compartment door is provided inside the wall and is fixed to a part other than the breakable portion of the glove compartment door, and the airbag case is attached to the reinforcement member.

2. The airbag apparatus for protecting knees according to claim 1, wherein a first latch member is fixed to the outside of the airbag case, and the airbag case is attached to the reinforcement member through the first latch member.

3. The airbag apparatus for protecting knees according to claim 1, wherein a lock device is provided in the glove compartment, a part of the constituent members of the lock device is disposed at the glove compartment door in order to hold the glove compartment door at a closed position, wherein the constituent member disposed at the glove compartment door among the constituent members of the lock device functions as the reinforcement member.

4. The airbag apparatus for protecting knees according to claim 1, wherein a lock device is provided in the glove compartment a part of the constituent members of the lock device is disposed at the glove compartment door in order to hold the glove compartment door at a closed position, wherein the airbag case is attached to the constituent member disposed at the glove compartment door among the constituent members of the lock devices, as well as to the reinforcement member.

5. The airbag apparatus for protecting knees according to claim 4, wherein a second latch member is fixed to the outside of the airbag case, and wherein the airbag case is attached to the constituent member disposed at the glove compartment door in the lock device by means of the second lock member.

6. The airbag apparatus for protecting knees according to claim 5, wherein the lock device includes, as the constituent members:
an engaging hole that is installed in a wall of the opening of the glove compartment ; and
an elongated lock member that is provided in the glove compartment door, wherein the lock member is displaced between an engaging position, where the lock member engages with the engaging hole to hold the glove compartment door at a closed position, and a disengaging position, where the lock member is removed from the engaging hole to cancel the engagement,
wherein the second latch member is movably latched to the lock member.

7. The airbag apparatus for protecting knees according to claim 5, wherein the lock device includes, as the constituent members:
a striker that is provided at one of the glove compartment door and the opening of the glove compartment;
a manipulation member that is provided at the other one of the glove compartment door and the opening, the manipulation member being rotatably supported by a shaft; and
a hook that is displaced, in response to rotation of the manipulation member, between an engaging position, where the hook is engaged with the striker to hold the glove compartment door at a closed position, and a disengaging position, where the hook cancels the engagement,
wherein the airbag case is attached to a constituent member among the striker and the shaft that is provided at the glove compartment door.

8. The airbag apparatus for protecting knees according to claim 1, wherein an end portion of the reinforcement member is positioned at a peripheral edge of the opening, and wherein a support member for connecting the end portion of the reinforcement member to a vehicle body strengthening member is provided.
